(19) United States
(12) Patent Application Publication
(10) Pub. No.: US 2022/0367953 A1
(43) Pub. Date: Nov. 17, 2022

(54) BATTERY MODULE

(71) Applicant: Mahle International GmbH, Stuttgart (DE)

(72) Inventors: Julius Aktas, Bietigheim-Bissingen (DE); Peter Geskes, Ostfildern (DE); Stefan Moedinger, Remseck A.n. (DE); Stephan Schild, Brackenheim (DE); Georg Votteler, Backnang (DE); Johannes Weinmann, Stuttgart (DE)

(21) Appl. No.: 17/739,116

(22) Filed: May 7, 2022

(30) Foreign Application Priority Data
May 12, 2021 (DE) 102021204825.0

(51) Int. Cl. H01M 50/209; H01M 50/262

(52) U.S. Cl. CPC H01M 50/209; H01M 50/262; H01M 2220/20

(57) ABSTRACT

A battery module for a traction battery of a battery electric vehicle and a method for manufacturing a battery module are disclosed. The battery module includes a cohesive battery cell stack and a module housing. A guide unit with at least two guide rails are provided on two opposite sides of the battery module. The battery cell stack is inserted into the module housing in a direction of insertion via the at least two guide rails and held transversely to the direction of insertion. The battery cell stack is bonded to the module housing via a cured adhesive. The cured adhesive defines a form-fitting unit that holds the battery cell stack in the module housing in at least one of a form-fitting and force-fitting manner.

### CROSS-REFERENCE TO RELATED APPLICATION

This application claims priority to German Application No. DE 10 2021 204 825.0 filed on May 12, 2021, the contents of which are hereby incorporated by reference in its entirety.

### TECHNICAL FIELD

The invention relates to a battery module for a traction battery of a battery electric vehicle. The invention also relates to a method for manufacturing the battery module.

### BACKGROUND

A battery module of a traction battery usually comprises a battery cell stack made up of several battery cells and a module housing. The battery cell stack, in this case, is arranged in the module housing and protected by the module housing. The battery cell stack should be securely and firmly fixed in the module housing over the service life. If the battery cell stack is designed for insertion into the module housing, however, clearance is always required between the battery cell stack and the module housing for easier insertion of the battery cell stack into the module housing. However, said clearance can be harmful to the battery cell stack during operation of the battery module, since relative movements between the battery cell stack and the module housing are possible. The aforementioned relative movements in the form of vibrations or jerky displacements due to rapid accelerations can lead to damage within the battery cell stack. The damage ranges from a failure of the battery module to a short-circuit or an exothermic reaction.

The object of the invention is therefore to specify an improved or at least alternative embodiment for a battery module of the generic type, in which the disadvantages described are overcome. The object of the invention is also to provide a corresponding method for manufacturing the battery module.

According to the invention, these objects are achieved by the subject matter of the independent claim(s). Advantageous embodiments are the subject matter of the dependent claims.

### SUMMARY

A battery module is provided for a traction battery of a battery electric vehicle. In this case, the battery module has a cohesive battery cell stack comprising several battery cells stacked on top of one another in a stacking direction and a module housing. The battery module also has a guide unit with at least two guide rails. The guide rails, in this case, are assigned to two opposite sides of the battery cell stack and aligned in a direction of insertion. The battery cell stack is inserted into the module housing in the direction of insertion via the guide rails and held transversely to the direction of insertion. According to the invention, the battery cell stack is bonded to the module housing by means of a curing adhesive. The cured adhesive forms a form-fitting unit that fixes the battery cell stack in the module housing, in and transversely to the direction of insertion, in a form-fitting and/or force-fitting manner.

Advantageously, the battery cell stack can be held in the module housing by the form-fitting unit, in and transversely to the direction of insertion, in a form-fitting and/or force-fitting manner, so that relative movements between the battery cell stack and the module housing are prevented. Consequently, the battery cell stack cannot be damaged as a result of the relative movements, and the battery cell stack is effectively protected. The form-fitting unit is advantageously formed from the cured adhesive and is accordingly adapted to the clearance between the module housing and the battery cell stack, in which the clearance deviates on a case-by-case basis. Accordingly, the relative movements between the battery cell stack and the module housing can be safely prevented, regardless of the existing tolerances.

Provision can advantageously be made for the guide rails to arrange the battery cell stack in the module housing transversely to the direction of insertion with a clearance gap. The form-fitting unit then bridges the clearance gap in the region of the respective guide rails, at least in places. The battery cell stack and the module housing can therefore be bonded to one another in places and regardless of the size of the clearance gap present in the individual case. In addition, the form-fitting unit can fix the battery cell stack in the module housing, in and transversely to the direction of insertion, in a form-fitting and/or force-fitting manner and regardless of the size of the clearance gap present in the individual case.

Advantageously, it can be provided that the form-fitting unit is formed by at least two distribution channels and several transverse bores that are fluidically connected to the respective distribution channels. The respective distribution channel is formed adjacent to the respective guide rail in the battery cell stack and is aligned in the direction of insertion. The transverse bores lead outwardly from the respective distribution channel into the module housing. Advantageously, the transverse bores can be evenly distributed over the length of the respective distribution channel. Advantageously, the transverse bores can have an identical diameter. Advantageously, the transverse bores can be identical to one another.

It can advantageously be provided that the cured adhesive completely fills the respective distribution channel and the respective transverse bores and exits outwardly from the transverse bores into the module housing. The cured adhesive, which has exited outwardly from the transverse bores, then connects the battery cell stack and the module housing to each other on the respective guide rail in a material-fitting and form-fitting and/or force-fitting manner. Advantageously, the battery cell stack can be bonded to the module housing in the region of the respective transverse bore and thereby bonded in places and connected in a form-fitting and/or force-fitting manner.

It can advantageously be provided that the distribution channel is open outwardly when the battery cell stack inserted into the module housing and can be filled with the adhesive from the outside. A length of the respective distribution channel can advantageously be equal to a length of the battery cell stack. Advantageously, the distribution channel can then be open outwardly on both sides. Advantageously, the adhesive can then be filled or injected into the distribution channel on both sides.

Provision can advantageously be made for the respective guide rail to have a first rail section and a second rail section. The first rail section is fixed or integrally formed on the battery cell stack, and the second rail section is fixed or integrally formed on the module housing. One rail section is arranged in the other rail section so as to be displaceable in the direction of insertion. Expediently, one rail section is arranged transversely to the direction of insertion with a clearance gap in the other rail section.

It can advantageously be provided that the distribution channel in the battery cell stack is formed adjacent to the first rail section. The distribution channel is aligned parallel to the first rail section, and the transverse bores lead out of the distribution channel outwardly towards the second rail section. If the curing adhesive is filled or injected into the distribution channel, the adhesive exits from the distribution channel at the transverse bores in the region of the first rail section and therefore of the second rail section. The clearance gap present between the first rail section and the second rail section is bridged by the adhesive or filled with the adhesive. The cured adhesive then forms a form-fitting unit that fixes the battery cell stack in the module housing, in and transversely to the direction of insertion, in a form-fitting and/or force-fitting manner.

It can advantageously be provided that the first rail section of the respective guide rail is formed by a first strip, which is aligned in the direction of insertion, and the second rail section of the respective guide rail is formed by two second strips, which are aligned in the direction of insertion and are parallel and spaced apart from one another. The respective first strip is arranged between the two second strips transversely to the direction of insertion.

Provision can advantageously be made for the direction of insertion and the stacking direction of the battery cell stack to coincide.

The invention also relates to a method for manufacturing the battery module described above. The battery cell stack is inserted into the module housing in the direction of insertion via the guide rails and held transversely to the direction of insertion. The battery cell stack is then bonded to the module housing using a curing adhesive. A form-fitting unit that fixes the battery cell stack in the module housing, in and transversely to the direction of insertion, in a form-fitting and/or force-fitting manner, is thereby formed from the cured adhesive. To avoid repetition, reference is made here to the above statements regarding the battery module.

As described above, the form-fitting unit can be formed by the at least two distribution channels and the several transverse bores that are fluidically connected to the respective distribution channels. In the method, the curing adhesive is then filled or injected into the distribution channel in such a way that the curing adhesive exits at the transverse bores and bridges or fills a clearance gap between the battery cell stack and the module housing. In order to avoid repetition, reference is made here to the above statements regarding the form-fitting unit.

Further important features and advantages of the invention result from the dependent claims, from the drawings, and from the associated description of the figures with reference to the drawings.

It is obvious that the features mentioned above and those yet to be explained below are usable not only in the combination specified in each case, but also in other combinations or in isolation, without departing from the scope of the present invention.

Preferred exemplary embodiments of the invention are illustrated in the drawings and explained in more detail in the following description, wherein the same reference symbols refer to identical or similar or functionally identical components.

### BRIEF DESCRIPTION OF THE DRAWINGS

In the schematic figures,

FIG. 1 shows a view of a battery module according to the invention with a battery cell stack which is partially inserted into a module housing;

FIG. 2 shows a partial sectional view of the battery module according to the invention in the region of a distribution channel;

FIG. 3 shows a sectional view of the battery cell stack of the battery module according to the invention in the region of the distribution channel;

FIG. 4 shows a view of the distribution channel with a transverse bore in the battery module according to the invention;

FIG. 5 shows a view of a form-fitting unit in the battery module according to the invention.

### DETAILED DESCRIPTION

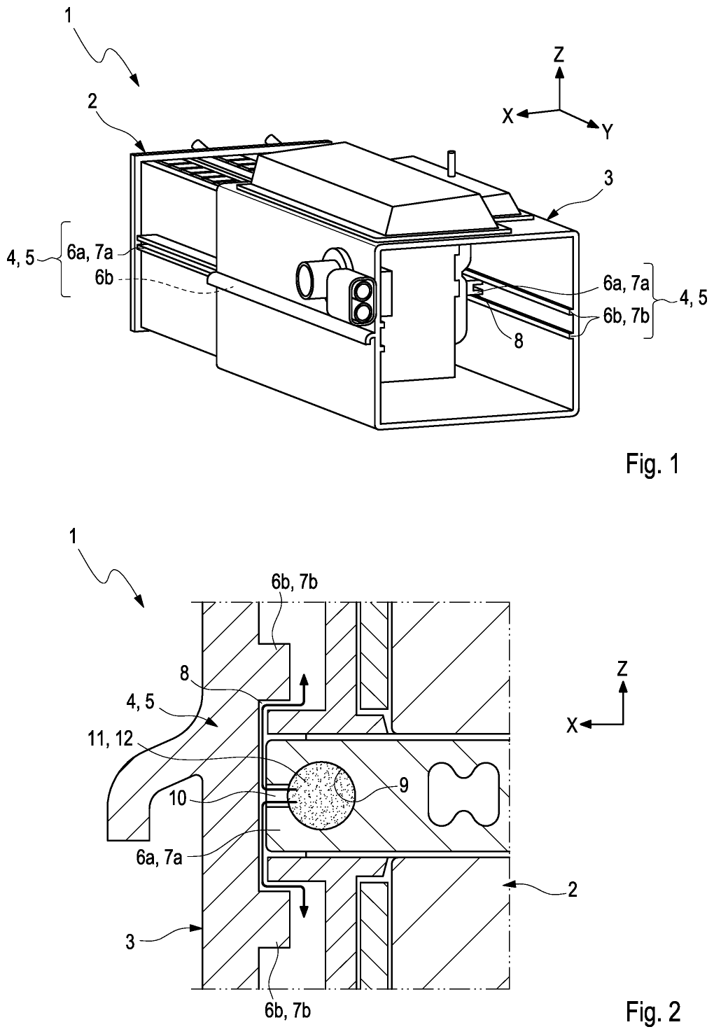

FIG. 1 shows a view of a battery module 1 according to the invention for a traction battery of a battery electric vehicle. In this case, the battery module 1 has a cohesive battery cell stack 2 comprising several battery cells stacked on top of one another in a stacking direction and a module housing 3. The battery module 1 also has a guide unit 4 with two guide rails 5. The guide rails 5, in this case, are assigned to two opposite sides of the battery module 2 and aligned in a direction of insertion Y. Accordingly, the battery cell stack 2 can be inserted into the module housing 3 in the direction of insertion Y. For this purpose, the module housing 3 is designed to be open on two opposite sides aligned transversely to the direction of insertion Y. The X-direction and Z-direction are also defined in the battery module 1 and aligned perpendicular to one another and to the direction of insertion Y. The stacking direction of the battery cells in the battery cell stack 2 corresponds to the direction of insertion Y here.

The respective guide rail 5 has a first rail section 6a with a strip 7a and a second rail section 6b with two strips 7b spaced apart from one another. The first rail section 6a is formed on the battery cell stack 2 approximately in the middle on the respective side surface of the battery cell stack 2. The second rail section 6b is formed on the module housing 3 facing the battery cell stack 2. The first strip 7a of the first rail section 6a is arranged in the Z-direction between the second strips 7b of the second rail section 6b.

A clearance gap 8 is formed between rail sections 6a and 6b in the Z-direction and in the X-direction, which clearance gap is provided for easier insertion of the battery cell stack 2 into the module housing 3. The structure of the battery module 1 according to the invention is explained in more detail below with reference to FIGS. 2-5.

FIG. 2 shows a partial sectional view of the battery module 1 according to the invention in an XZ-plane aligned transversely to the direction of insertion Y. As can be seen here, the battery cell stack 2 contains two distribution channels 9—only one shown here—with several transverse bores 10—only one shown here. The transverse bores 10 lead outwardly from the respective distribution channel 9 into the module housing 3. The respective distribution channel 9 is formed adjacent to the respective guide rail 5. In particular, the respective distribution channel 9 is formed directly adjacent to the respective first rail section 6a, and the respective transverse bores 10 lead directly to the respective second rail section 6b. As a result, the respective transverse bores 10 open directly into the clearance gap 8 which is formed between respective rail sections 6a and 6b in the Z-direction and in the X-direction.

The respective distribution channel 9 is filled with a curing adhesive 11. As indicated by arrows, the adhesive 11 exits from the distribution channel 9 via the transverse bores 10 into the clearance gap 8 and fills the clearance gap 8. As a result, the battery cell stack 2 and the module housing 3 are bonded to one another by the cured adhesive 11. In addition, a form-fitting unit 12 that fixes the battery cell stack 2 in the module housing 3, in and transversely to the direction of insertion Y, in a form-fitting and/or force-fitting manner, is thereby formed from the cured adhesive 11.

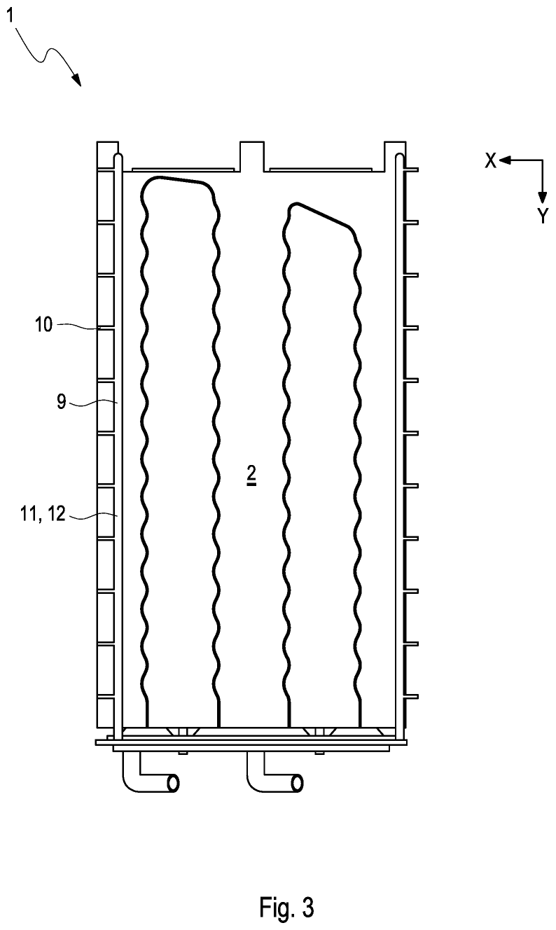

FIG. 3 shows a sectional view of the battery cell stack 2 in an XY-plane aligned transversely to the Z-direction in the region of the distribution channel 9. As can be seen in FIG. 3, the respective distribution channel 9 is open on both sides, so that the adhesive 11 can be filled or injected into the respective distribution channel 9. It can also be seen in FIG. 3 that several transverse bores 10 open into the respective distribution channel 9 and that the respective transverse bores 10 are evenly distributed over the length of the respective distribution channel 9.

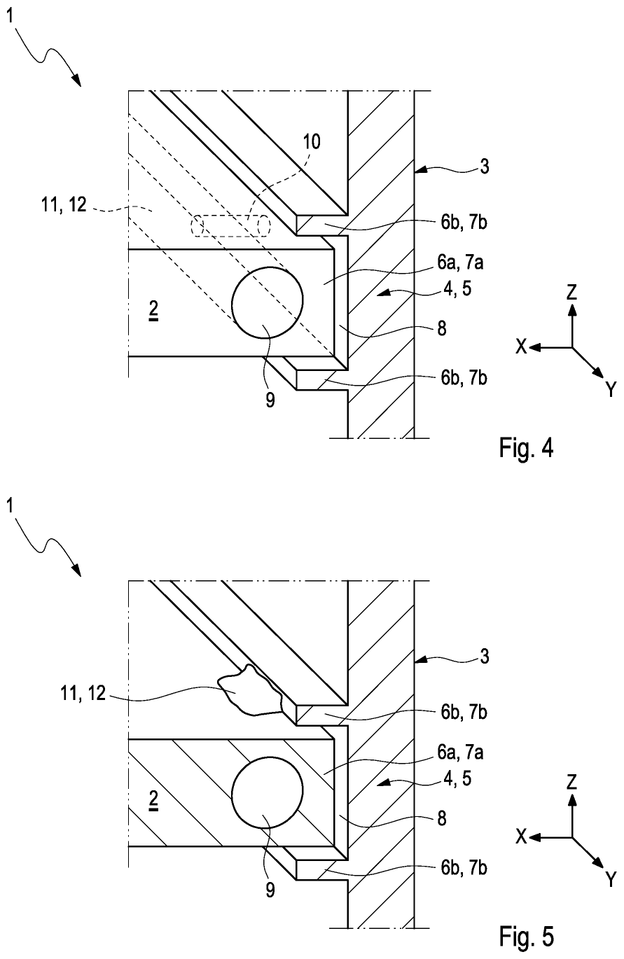

FIG. 4 then shows a view of the distribution channel 9 with one of the transverse bores 10. FIG. 4 shows particularly clearly that the respective transverse bore 10 connects the respective distribution channel 9 and the clearance gap 8 to one another.

FIG. 5 shows a view of the form-fitting unit 12. As can be seen particularly well here, the cured adhesive 11 connects the battery cell stack 2 and the module housing 3 to one another in places in a material-fitting manner and forms the form-fitting unit 12, which connects the battery cell stack 2 and the module housing 3 to one another in a form-fitting and/or force-fitting manner.

1. A battery module for a traction battery of a battery electric vehicle, comprising:
a cohesive battery cell stack including a plurality of battery cells stacked on top of one another in a stacking direction and a module housing,
a guide unit with at least two guide rails that are assigned to two opposite sides and aligned in a direction of insertion,
wherein the battery cell stack is inserted into the module housing in the direction of insertion via the at least two guide rails and held transversely to the direction of insertion, and
wherein the battery cell stack is bonded to the module housing via a cured adhesive, wherein the cured adhesive defines a form-fitting unit that holds the battery cell stack in the module housing, in and transversely to the direction of insertion, in at least one of a form-fitting and a force-fitting connection.

2. The battery module according to claim 1, wherein:
the at least two guide rails arrange the battery cell stack in the module housing transversely to the direction of insertion with a clearance gap, and
the form-fitting unit bridges the clearance gap in a region of the at least two guide rails, respectively, at least in some places.

3. The battery module according to claim 1, wherein:
the form-fitting unit is provided by at least two distribution channels and a plurality of transverse bores fluidically connected to the respective distribution channels,
the at least two distribution channels are disposed adjacent to the at least two guide rails in the battery cell stack, respectively, and aligned in the direction of insertion, and
the plurality of transverse bores lead outwardly from the respective distribution channels into the module housing.

4. The battery module according to claim 3, wherein:
the cured adhesive completely fills the at least two distribution channels and the plurality of transverse bores and exits outwardly from the plurality of transverse bores into the module housing, and
a portion of the cured adhesive that has exited outwardly from the plurality of transverse bores connects the battery cell stack and the module housing to one another on the at least two guide rails in a material-fitting connection and the at least one of the form-fitting and the force-fitting connection.

5. The battery module according to claim 3, wherein at least one of the at least two distribution channels is open outwardly when the battery cell stack is inserted into the module housing and is filled with the cured adhesive from the outside.

6. The battery module according to claim 1, wherein:
the at least two guide rails respectively have a first rail section and a second rail section,
the first rail section is fixed or integrally formed on the battery cell stack, and the second rail section is fixed or integrally formed on the module housing, and
the first rail section is arranged in the second rail section, or vice versa, so as to be displaceable in the direction of insertion.

7. The battery module according to claim 3, wherein the at least two guide rails respectively include a first rail section arranged on the battery cell stack and a second rail section arranged on the module housing, wherein:
the at least two distribution channels in the battery cell stack are arranged adjacent to the first rail section, and
the at least two distribution channels are aligned parallel to the first rail section, and the plurality of transverse bores lead out of the at least two distribution channels outwardly towards the second rail section.

8. The battery module according to claim 6, wherein:
the first rail section of the at least two guide rails is provided by a first strip aligned in the direction of insertion, and the second rail section of the at least two guide rails is provided by two second strips that are aligned in the direction of insertion and are parallel and spaced apart from one another, and
the first strip is arranged between the two second strips transversely to the direction of insertion.

9. The battery module according to claim 1, wherein the direction of insertion and the stacking direction of the battery cell stack coincide.

10. A method for manufacturing a battery module, comprising:
inserting a battery cell stack into a module housing in a direction of insertion via at least two guide rails of a guide unit and holding the battery cell stack transversely to the direction of insertion, and
bonding the battery cell stack to the module housing via a curing adhesive to form a form-fitting unit that holds the battery cell stack in the module housing (3) in and transversely to the direction of insertion, in at least one of a form-fitting and a force-fitting manner.

11. The method according to claim 10, wherein the form-fitting unit is formed by at least two distribution channels and a plurality of transverse bores fluidically connected to the at least two distribution channels;
wherein bonding the battery cell stack includes filling the at least two distribution channels and the plurality of transverse bores with the curing adhesive such that the curing adhesive exits outwardly from the plurality of bores and connects the battery cell stack to the module housing.

12. The method according to claim 11, wherein at least one of the at least two distribution channels is open outwardly when the battery cell stack is inserted into the module housing and is filled with the curing adhesive from the outside.

13. A traction battery for a battery electric vehicle, comprising: a battery module, the battery module including:
a cohesive battery cell stack including a plurality of battery cells stacked on top of one another in a stacking direction and a module housing;
a guide unit including at least two guide rails that are assigned to two opposite sides of the battery module and aligned in a direction of insertion;
wherein the battery cell stack is inserted into the module housing in the direction of insertion via the at least two guide rails and held transversely to the direction of insertion; and
wherein the battery cell stack is bonded to the module housing via a cured adhesive, wherein the cured adhesive defines a form-fitting unit that holds the battery cell stack in the module housing, in and transversely to the direction of insertion, in at least one of a form-fitting and a force-fitting connection.

14. The traction battery according to claim 13, wherein:
the at least two guide rails arrange the battery cell stack in the module housing transversely to the direction of insertion with a clearance gap; and
the form-fitting unit bridges the clearance gap in a region of the at least two guide rails, respectively, at least in some places.

15. The traction battery according to claim 13, wherein:
the form-fitting unit is provided by at least two distribution channels and a plurality of transverse bores fluidically connected to the respective distribution channels;
the at least two distribution channels are disposed adjacent to the at least two guide rails in the battery cell stack, respectively, and aligned in the direction of insertion; and
the plurality of transverse bores lead outwardly from the respective distribution channels into the module housing.

16. The traction battery according to claim 15, wherein:
the cured adhesive completely fills the at least two distribution channels and the plurality of transverse bores and exits outwardly from the plurality of transverse bores into the module housing; and
a portion of the cured adhesive that has exited outwardly from the plurality of transverse bores connects the battery cell stack and the module housing to one another on the at least two guide rails in a material-fitting connection and the at least one of the form-fitting and the force-fitting connection.

17. The traction battery according to claim 15, wherein at least one of the at least two distribution channels is open outwardly when the battery cell stack is inserted into the module housing and is filled with the cured adhesive from the outside.

18. The traction battery according to claim 15, wherein:
the at least two guide rails respectively have a first rail section and a second rail section;
the first rail section is arranged on the battery cell stack, and the second rail section is arranged on the module housing; and
the first rail section is arranged in the second rail section, or vice versa, so as to be displaceable in the direction of insertion.

19. The traction battery according to claim 18, wherein:
the at least two distribution channels in the battery cell stack are arranged adjacent to the first rail section; and
the at least two distribution channels are aligned parallel to the first rail section, and the plurality of transverse bores lead out of the at least two distribution channels outwardly towards the second rail section.

20. The traction battery according to claim 19, wherein:
the first rail section of the at least two guide rails is provided by a first strip aligned in the direction of insertion, and the second rail section of the at least two guide rails is provided by two second strips that are aligned in the direction of insertion and are parallel and spaced apart from one another; and
the first strip is arranged between the two second strips transversely to the direction of insertion.
